(19) United States
(12) Patent Application Publication
(10) Pub. No.: US 2026/0023940 A1
(43) Pub. Date: Jan. 22, 2026

(54) MULTILINGUAL GENERATIVE MODEL(S)

(71) Applicant: GOOGLE LLC, Mountain View, CA (US)

(72) Inventors: Aditya Barua, Mountain View, CA (US); Steven Zheng, San Bruno, CA (US); HyunJeong Choe, Monte Sereno, CA (US); Siddharth Gopal, Sunnyvale (CA); Sushil Mittal, Mountain View, CA (US); Motoki Sano, Mountain View, CA (US); Soo Kwak, Mountain View, CA (US); Akhil Udathu, Mountain View, CA (US)

(21) Appl. No.: 19/275,524

(22) Filed: Jul. 21, 2025

Related U.S. Application Data
(60) Provisional application No. 63/674,010, filed on Jul. 22, 2024.

(51) Int. Cl. G06F 40/58; G06F 16/334; G06F 40/263

(52) U.S. Cl. CPC G06F 40/58; G06F 16/3344; G06F 40/263

(57) ABSTRACT

Various implementations include fine-tuning a multilingual large language model (ML-LLM). Many implementations include converting a base instance of natural language (NL) input text into a revised instance of NL input text, where the base instance of NL input text is in a first language and includes a portion corresponding to a first geographic location, and where the revised instance of NL input text is in a second language and includes a portion corresponding to a second geographic location.

### BACKGROUND

Generative models (GMs), such as large language models (LLMs), are machine learning models that are trained on enormous amounts of diverse data that can perform various natural language processing (NLP) tasks. Recent developments have integrated aspects into LLMs into interpreting and responding to natural language (NL) based input, such as NL based input provided by a user during a human-to-computer dialog session.

Recent developments include multilingual (ML) LLMs, where the ML-LLM can generate responsive output, in more than one language, to NL based input in the one or languages (e.g., the ML-LLM can process NL based input in English to generate responsive output in English and the same ML-LLM can process NL based input in German to generate responsive output in German). However, when trained using a high volume of training instances in a single language, the ML-LLM can be subject to catastrophic forgetting, where the ML-LLM loses the ability to respond in a previously trained language. Additionally, it can be infeasible to maintain separate LLMs for individual languages (e.g., maintaining 100 LLMs, each corresponding to a distinct language, where each LLM contains billions of parameters is infeasible). Additionally or alternatively, ML-LLMs can struggle to between two (or more) linguistically similar languages (e.g., between Danish and Swedish, between French and Italian, etc.). Consequently, the ML-LLM may process NL based input in a first language but generate output in a second linguistically similar language.

### SUMMARY

Implementations described herein are directed towards fine-tuning a ML-LLM to encourage the ML-LLM to generate NL text output in the same language as the NL text input. In some implementations, the ML-LLM can be fined-tuned using one or more instances of fine-tuning data, where an instance of fine-tuning data is generated based on processing a base instance of NL input text in a first language to generate a revised instance of the NL input text in the second language. In some implementations, the base instance of NL input text includes a portion corresponding to a first geographic location and the revised instance of NL input text includes a portion corresponding to a second geographic location. For example, a base instance of NL input text of “Give me 5 attractions to visit in the Bay Area” is written in English (the first language) and includes the ‘Bay Area’ (the portion corresponding to the first geographic location). A corresponding revised instance of NL input text of “Datemi 5 attrazioni da visitare a Venezia” written in Italian (the second language) and includes ‘Venice’ (the portion corresponding to the second geographic location).

In some implementations, the fine-tuning can be paired with a prefix indicating the language and the location. For example, “Give me 5 attractions in the Bay Area” can be paired with the prefix [en-US] indicating the language is English and the geographic location is the United States. Similarly, of “Datemi 5 attrazioni da visitare a Venezia” can be paired with the prefix [it-IT] indicating the language is Italian and the geographic location is Italy. The same language can be spoken in different countries. However, there can still be regional differences between the countries, such as different currencies, different capitals, different famous locations, and/or one or more additional or alternative regional differences. In some implementations, the prefix is an additional indication of the language of the desired output and can be appended to the NL text input for processing by the ML-LLM (e.g., for processing at inference). In some implementations, the system can automatically generate the prefix. In some other implementations, the user can provide the prefix (or a portion of the prefix).

In some implementations, the revised instance of NL input text can be generated based on the base instance of NL input text. The portion of the base instance of NL input text in the first language and corresponding to the first geographic location can be processed to generate an updated portion of the base instance of NL input text in the first language and corresponding to the second geographic location. An updated instance of NL input text can be generated by replacing, in the base instance of NL input text, the portion corresponding to the first geographic location with the updated portion that corresponds to the second geographic location, where the updated instance of NL input text is in the first language. For instance, ‘Bay Area’ can be replaced with ‘Venice’ in “Give me 5 attractions in the Bay Area” to generate the updated instance of NL input text of “Give me 5 attractions in Venice”. In some implementations, the revised instance of NL input text can be generated by translating the revised instance of NL input text from the first language into the second language. For example, “Give me 5 attractions in Venice” can be translated from English to Italian to generate the revised instance of NL input text of “Datemi 5 attrazioni da visitare a Venezia”.

Accordingly, various implementations set forth techniques for fine-tuning a ML-LLM to increase the likelihood the ML-LLM generates output that is in the same language as the input. When processing a given instance of NL input text in a given language, the fine-tuned ML-LLM generates responsive content in the given language. In contrast, when the same given instance of NL input text in the given language is processed by a ML-LLM without such fine-tuning to generate responsive output, the responsive output is in an additional language that is distinct from the given language. When responsive output in the incorrect language is generated, the user must provide an additional instance of NL input text (either repeating the given instance and/or provide a distinct instance) and the additional instance of NL input text must be processed by the ML-LLM to generate additional responsive output. When the user understands the language of the responsive output, the user does not need to provide the additional NL input text and/or wait for the additional NL input text to be processed. In other words, the system does not need to use computing resources (e.g., processor cycles, memory, battery power, etc.) to process additional NL input text to generate a response in a language understood by the user.

The above description is provided only as an overview of some implementations disclosed herein. These and other implementations of the technology are disclosed in additional detail below. It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1A illustrates an example of generating a revised instance of natural language input text based on a base instance of natural language input text in accordance with various implementations disclosed herein.

FIG. 1B illustrates an example of fine-tuning a multilingual large language model in accordance with various implementations disclosed herein.

FIG. 2 illustrates an example of converting a base instance of natural language input text into a revised instance of natural language input text in accordance with various implementations disclosed herein.

FIG. 3 is a flowchart illustrating an example process of generating a revised instance of natural language input text based on a base instance of natural language input text in accordance with various implementations disclosed herein.

FIG. 4 is a flowchart illustrating an example process of fine tuning a multilingual large language model in accordance with various implementations disclosed herein.

FIG. 5 is a flowchart illustrating an example process of processing natural language input text using a multilingual large language model in accordance with various implementations disclosed herein.

FIG. 6 illustrates an example environment in which various implementations described herein may be implemented.

FIG. 7 illustrates another example environment in which various implementations disclosed herein may be implemented.

FIG. 8 illustrates an example architecture of a computing device.

### DETAILED DESCRIPTION

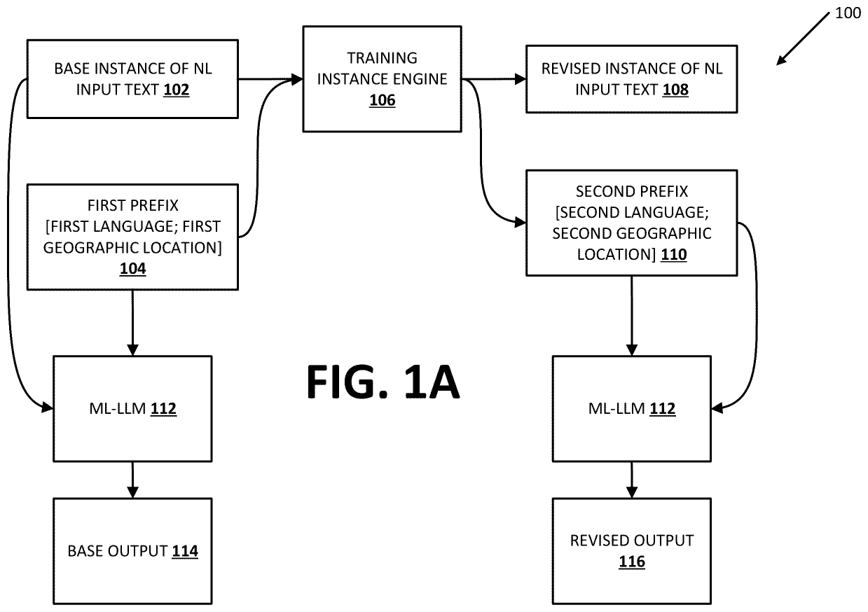

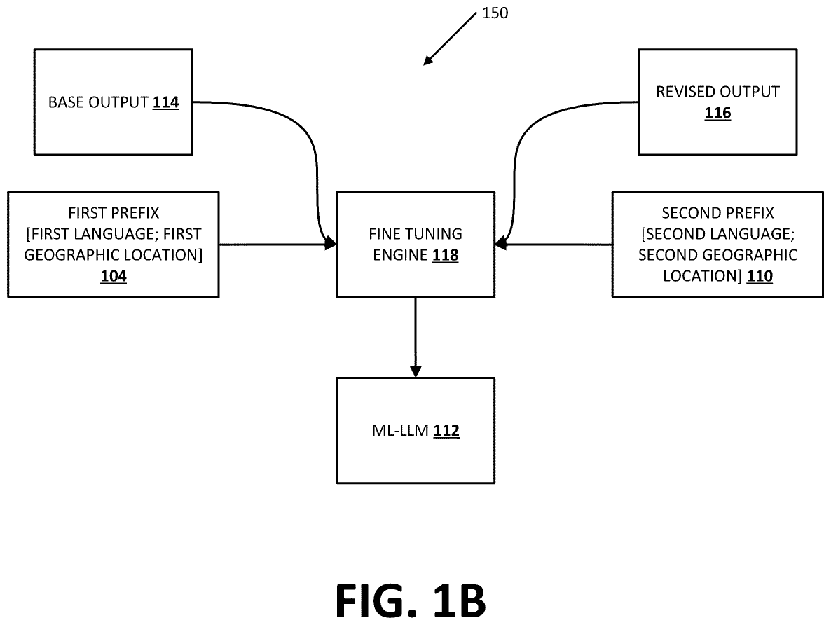

Turning now to the figures, FIG. 1A illustrates an example 100 of processing a base instance of NL input text in a first language to generate a revised instance of NL input text in a second language. The illustrated example 100 includes a base instance of NL input text 102 which is paired with a first prefix 104. The base instance of NL input text 102 is in a first language and includes a portion corresponding to a first geographic location. The first prefix 104 includes an indication of the first language and an indication of the first geographic location. In some implementations, the base instance of NL input text 102 and the first prefix 104 can be processed using a training instance engine 106 to generate a revised instance of NL input text 108. Additionally or alternatively, the training instance engine 106 can pair a second prefix 110 with the revised instance of NL input text 108 based on the converting of the base instance to the revised instance. In some implementations, the second prefix 110 can include an indication of a second geographic location and an indication of a second geographic location.

In some implementations, the system can generate base output 114 based on processing the base instance of NL input text 102 and the first prefix 104 using the ML-LLM 112. Additionally or alternatively, the system can generate revised output 116 based on processing the revised instance of NL input text 108 and the second prefix 110 using the ML-LLM 112.

FIG. 1B illustrates an example 150 of fine-tuning the ML-LLM 112 based on the base output 114 and revised output 116 generated in FIG. 1A. Fine-tuning engine 118 can process the base output 114, the first prefix 104, the revised output 116, the second prefix 110, the base instance of NL input text 102 (not depicted), and/or the revised instance of NL input text 108 (not depicted) to generate fine-tuning output for use in fine-tuning one or more portions of ML-LLM 112.

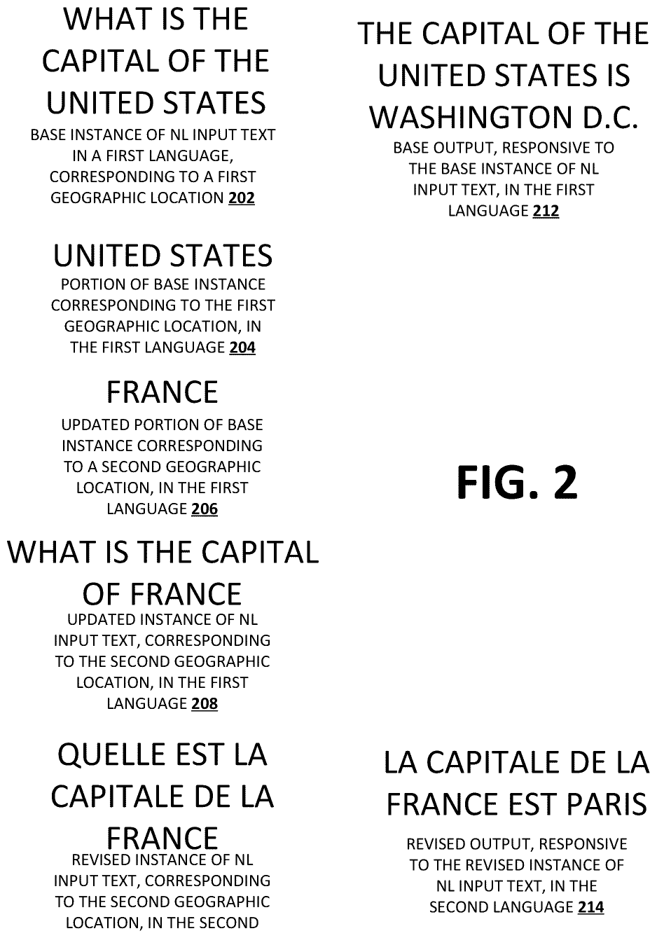

FIG. 2 includes an example base instance of NL text input 202 of “WHAT IS THE CAPITAL OF THE UNITED STATES” which is in English (e.g., the first language). The base instance of NL text input 202 includes a portion of the base instance corresponding to the first geographic location, in the first language 204 of “UNITED STATES”. In additional or alternative implementations, the portion of the base instance of NL input text corresponding to the first geographic location, in the first language 204 can include one or more additional portions of the base instance of the base instance of NL input text and/or one or fewer portions of the base instance of NL input text. For example, the portion of the base instance 204 could include the additional word “THE” (e.g., the portion of the base instance of NL input text of “THE UNITED STATES”), the additional words “CAPITAL OF THE” (e.g., the portion the base instance of NL input text of “CAPITAL OF THE UNITED STATES”), etc.

The updated portion of the base instance corresponding to the second geographic language, in the first language 206 of “FRANCE” can be generated based on the portion of the base instance corresponding to the first geographic location, in the first language 204 of “UNITED STATES”. In some implementations, the system can generate the updated portion of the base instance by identifying a node, in a knowledge graph, that corresponds to the portion of the base instance corresponding to the first geographic location. For example, the system can identify a node in a knowledge graph corresponding to “CAPITAL OF THE UNITED STATES”. Additionally or alternatively, the system can identify an updated node corresponding to the second geographic location of “CAPITAL OF FRANCE” based, at least in part, on the relationship between the “CAPITAL OF THE UNITED STATES” node and the “CAPITAL OF FRANCE” updated node. In some implementations, the system can generate the updated portion of the base instance corresponding to the second geographic location based at least in part on processing the base instance of NL input text, the first prefix, and/or the second prefix using a search engine to generate search engine output. The updated portion of the base instance corresponding to the second geographic location can be based on the search engine output. Additionally or alternatively, the system can generate the updated portion of the base instance corresponding to the second geographic location using a generative model. For example, the system can process a NL text query (based on at least the portion of the base instance of NL input text corresponding to the first geographic location and the second geographic location) using a generative model to generate the updated portion of the base instance corresponding to the second geographic location.

In some implementations, the system can generate the updated instance of NL input text, corresponding to the second geographic location, in the first language 208 by substituting the portion of the base instance corresponding to the first geographic location 204 with the updated portion of the base instance corresponding to the second geographic location 206 in the base instance of NL input text 202. For example, the system can substitute “UNITED STATES” with “FRANCE” in the base instance of NL input text of “WHAT IS THE CAPITAL OF THE UNITED STATES” to generate the updated instance of NL input text, corresponding to the second geographic location, in the first language 208 of “WHAT IS THE CAPITAL OF FRANCE”.

Additionally or alternatively, the system can generate the revised instance of NL input text, corresponding to the second location, in the second language 210 of “QUELLE EST LA CAPITALE DE LA FRANCE” by translating the updated instance of NL input text 208 OF “WHAT IS THE CAPITAL OF FRANCE” from the first language (English) into the second language (French).

In some implementations, the system can process the base instance of NL input text 202 of “WHAT IS THE CAPITAL OF THE UNITED STATES” using the ML-LLM to generate the base output, responsive to the base instance of NL input text, in the first language 212 of “THE CAPITAL OF THE UNITED STATES IS WASHINGTON D.C.”. Additionally or alternatively, the system can process the revised instance of NL input text 210 of “QUELLE EST LA CAPITALE DE LA FRANCE” using the ML-LLM to generate the revised output, responsive to the revised instance of NL input text, in the second language 214 of “LA CAPITALE DE LA FRANCE EST PARIS”.

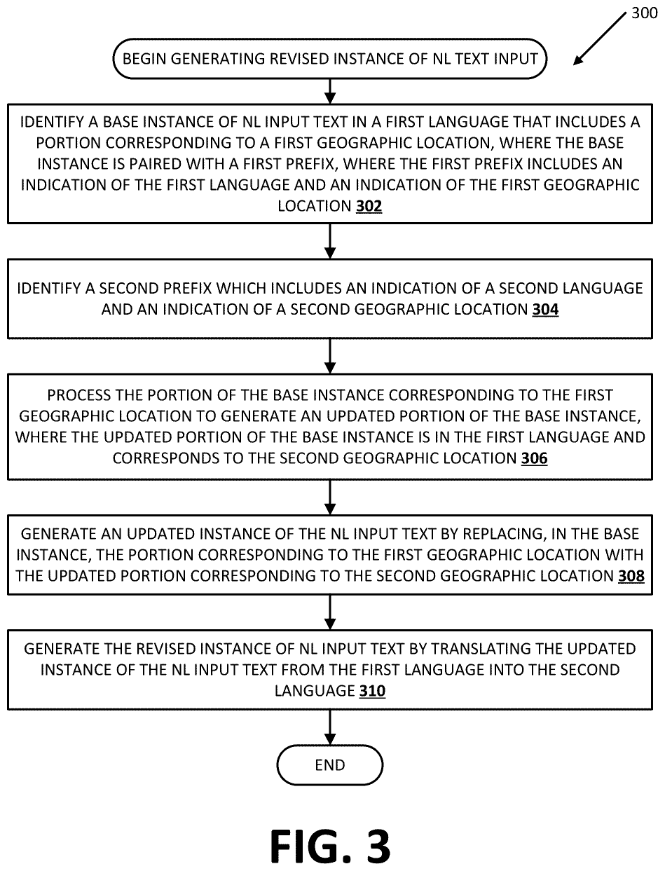

FIG. 3 is a flowchart illustrating an example process 300 of generating an example process of generating a revised instance of natural language input text based on a base instance of natural language input text in accordance with various implementations disclosed herein. For convenience, the operations of the flowchart are described with reference to a system that performs the operations. This system may include various components of various computer systems, such as one or more components of client device 602, client device 702, and/or computing system 810. Moreover, while operations of process 300 are shown in a particular order, this is not meant to be limiting. One or more operations may be reordered, omitted, and/or added.

At block 302, the system identifies a base instance of NL input text in a first language that includes a portion corresponding to a first geographic location, where the base instance is paired with a first prefix. In some implementations, the first prefix includes an indication of the first language and an indication of the first geographic location. For example, the system can identify the base instance of NL input text 102 and first prefix 104 described with respect to FIG. 1A and/or the base instance of NL input text 202 described with respect to FIG. 2.

At block 304, the system identifies a second prefix which includes an indication of a second language and an indication of a second geographic location. For example, the system can identify the second prefix 110 as described in FIG. 1A.

At block 306, the system processes the portion of the base instance of NL input text corresponding to the first geographic location to generate an updated portion of the base instance of NL input text. In some of those implementations, the updated portion of the base instance of NL input text is in the first language and corresponds to the second geographic location. For example, the system can generate an updated portion of the base instance corresponding to the second geographic location 206 as described with respect to FIG. 2. In some implementations, the system can generate the updated portion of the base instance by identifying a node, in a knowledge graph, that corresponds to the portion of the base instance corresponding to the first geographic location. Additionally or alternatively, the system can identify an updated node corresponding to the second geographic location of based, at least in part, on the relationship between the base node and the updated node. In some implementations, the system can generate the updated portion of the base instance corresponding to the second geographic location based at least in part on processing the base instance of NL input text, the first prefix, and/or the second prefix using a search engine to generate search engine output. The updated portion of the base instance corresponding to the second geographic location can be based on the search engine output. Additionally or alternatively, the system can generate the updated portion of the base instance corresponding to the second geographic location using a generative model. For example, the system can process a NL text query (based on at least the portion of the base instance of NL input text corresponding to the first geographic location and the second geographic location) using a generative model to generate the updated portion of the base instance corresponding to the second geographic location.

At block 308, the system generates an updated instance of the NL input text by replacing, in the base instance of NL input text, the portion corresponding to the first geographic location with the updated portion corresponding to the second geographic location. For example, the system can generate the updated instance of NL input text 208 by substituting the portion of the base instance corresponding to the first geographic location 204 with the updated portion of the base instance corresponding to the second geographic location 206 in the base instance of NL input text 202.

At block 310, the system generates the revised instance of NL input text by translating the updated instance of the NL input text from the first language to the second language. For example, the system can process the updated instance of NL input text, corresponding to the second geographic location 208 using a translation engine to generate the revised instance of NL input text, corresponding to the second geographic location, in the second language 210 as described herein with respect to FIG. 2.

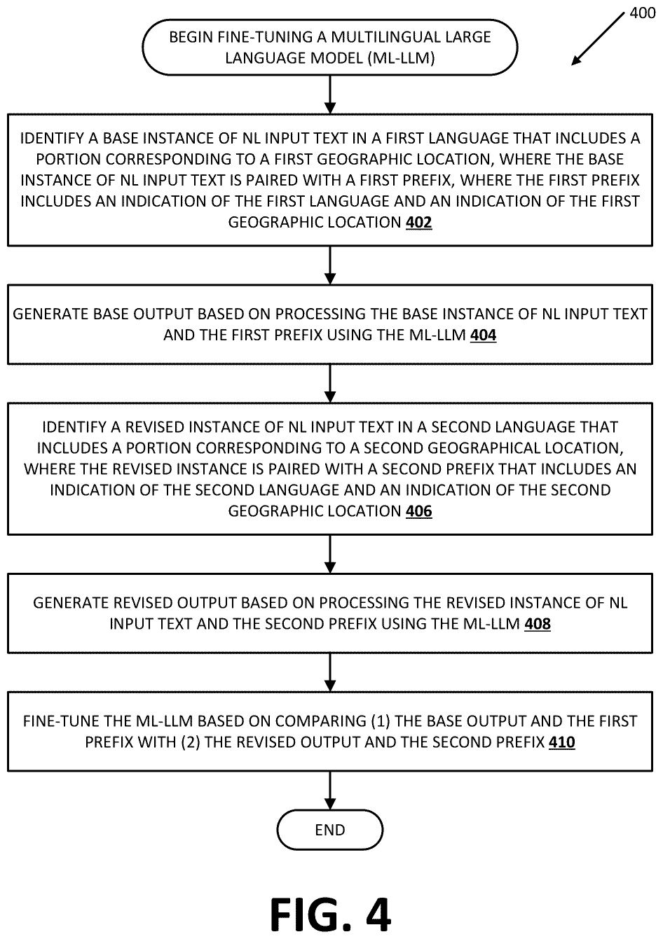

FIG. 4 is a flowchart illustrating an example process 400 of fine tuning a multilingual large language model in accordance with various implementations disclosed herein. For convenience, the operations of the flowchart are described with reference to a system that performs the operations. This system may include various components of various computer systems, such as one or more components of client device 602, client device 702, and/or computing system 810. Moreover, while operations of process 400 are shown in a particular order, this is not meant to be limiting. One or more operations may be reordered, omitted, and/or added.

At block 402, the system identifies a base instance of NL input text in a first language that includes a portion corresponding to a first geographic location. In some implementations, the base instance of NL input text is paired with a first prefix. In some versions of those implementations, the first prefix includes an indication of the first language and an indication of the first geographic location. For example, the system can identify the base instance of NL input text in the first language, corresponding to the first geographic location 102 as described herein with respect to FIG. 1A.

At block 404, the system generates base output based on processing the base instance of NL input text and the first prefix using the ML-LLM. For example, the system can process the base instance of NL input 102 and the first prefix indicating the geographic location and language of the base instance of NL input using the ML-LLM 112 to generate base output 114 as described herein with respect to FIG. 1A.

At block 406, the system identifies a revised instance of NL input text in a second language that includes a portion corresponding to a second geographic location. In some implementations, the revised instance of NL input text is paired with a second prefix that includes an indication of the second language and an indication of the second geographic location. In some implementations, the revised instance of NL input text in the second language that includes a portion corresponding to the second geographic location can be generated in accordance with process 300 as described herein with respect to FIG. 3. For example, the system can generate the revised instance of NL input text 108 which is paired with the second prefix 110 as described herein with respect to FIG. 1A.

At block 408, the system generates revised output based on processing the revised instance of NL input text and the second prefix using the ML-LLM. For example, the system can generate revised output 116 based on processing the revised instance of NL input text 108 and the second prefix 110 using ML-LLM 112 as described herein with respect to FIG. 1A.

At block 410, the system fine-tunes the ML-LLM based on comparing (1) the base output and the first prefix with (2) the revised output and the second prefix. For example, the fine-tuning engine 118 can process the base output 114, the first prefix 104, the revised output 116, and the second prefix 110 to generate fine-tuning output. Additionally or alternatively, the fine-tuning output can be used to fine-tune the ML-LLM 112 described herein with respect to FIG. 1B.

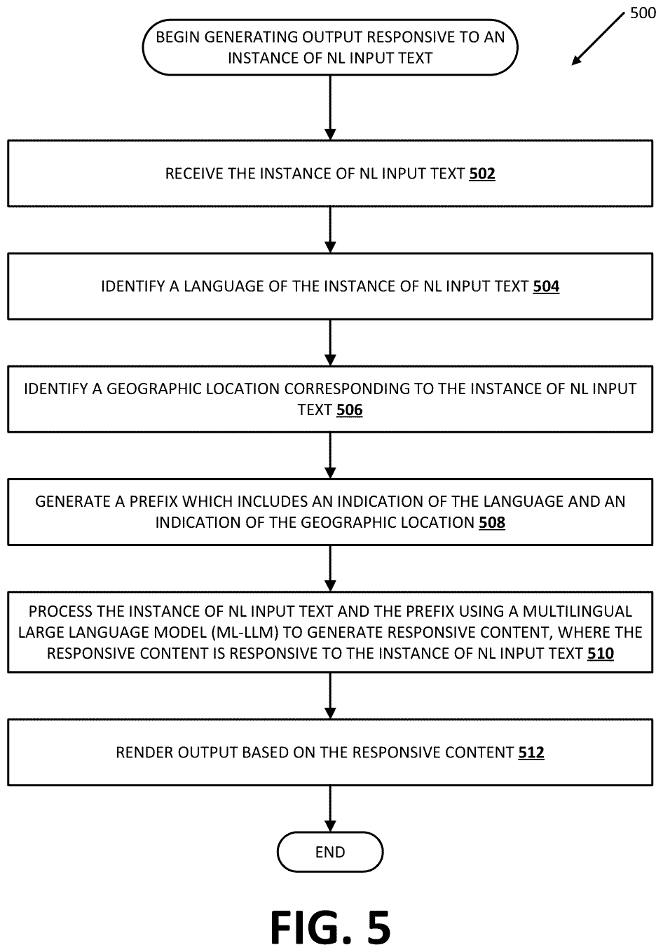

FIG. 5 is a flowchart illustrating an example process 500 of processing natural language input text using a multilingual large language model in accordance with various implementations disclosed herein. For convenience, the operations of the flowchart are described with reference to a system that performs the operations. This system may include various components of various computer systems, such as one or more components of client device 602, client device 702, and/or computing system 810. Moreover, while operations of process 500 are shown in a particular order, this is not meant to be limiting. One or more operations may be reordered, omitted, and/or added.

At block 502, the system receives an instance of NL input text. In some implementations, the system can process audio data of a user speaking an utterance using an automatic speech recognition (ASR) model to generate the instance of NL input text, where the instance of NL input text is a text representation of the spoken utterance. Additionally or alternatively, the instance of NL input text can be provided by a user via one or more additional or alternative user interface input devices such as a keyboard. In some implementations, the system can receive the instance of NL input text from an additional computing device.

At block 504, the system identifies a language of the instance of NL input text. In some implementations, the system can identify the language of the instance of NL input text based on a language identified as a known language of the user in a user profile corresponding to the user; the system can identify the language based on one or more language settings of the device (e.g., based on the language set on the client device); the user can select the language prior to speaking the utterance; the user can select the language after speaking the utterance; the system can process the NL input text using a language identification model to determine the language; the system can identify the language in one or more additional or alternative ways and/or combinations thereof.

At block 506, the system identifies a geographic location corresponding to the instance of NL input. In some implementations, the system can identify the geographic location based client device sensor data identifying the location (e.g., GPS data); the system can identify the geographic location based on client device user activity (e.g., the client device providing directions to a location to the user, the user creating a calendar entry identifying a location, the user purchasing plane tickets, etc.); the user can select the geographic location; the system can identify the geographic language in one or more additional or alternative ways and/or combinations thereof.

At block 508, the system generates a prefix which includes an indication of the language and an indication of the geographic location. In some implementations, the prefix can include an abbreviation of the language and/or an abbreviation of the geographic language. For example, the system can generate a prefix of [fr-FR] when the language is French and the geographic location is France. Additionally or alternatively, the system can generate a prefix of [fr-CN] when the language is French and the geographic location is Canada.

At block 510, the system processes the instance of NL input text and the prefix using a ML-LLM to generate responsive content. In some implementations, the responsive content is responsive to the instance of NL input text.

For example, the system can receive NL input text of “Quelle est la capitale de la France”. Additionally or alternatively, the system can identify the language of the NL input text as French, and the location as France. In some implementations, the system can generate the prefix of [fr-FR] corresponding to the French language and the geographic location of France. The system can process “[fr-FR] Quelle est la capitale de la France” using the ML-LLM to generate responsive content of “la capitale de la France est Paris”.

At block 512, the system renders output based on the responsive content. For example, the system can render output based on the responsive content via one or more display devices of the client device. Additionally or alternatively, the system can process the responsive content using a text to speech model to generate audio output of the responsive content.

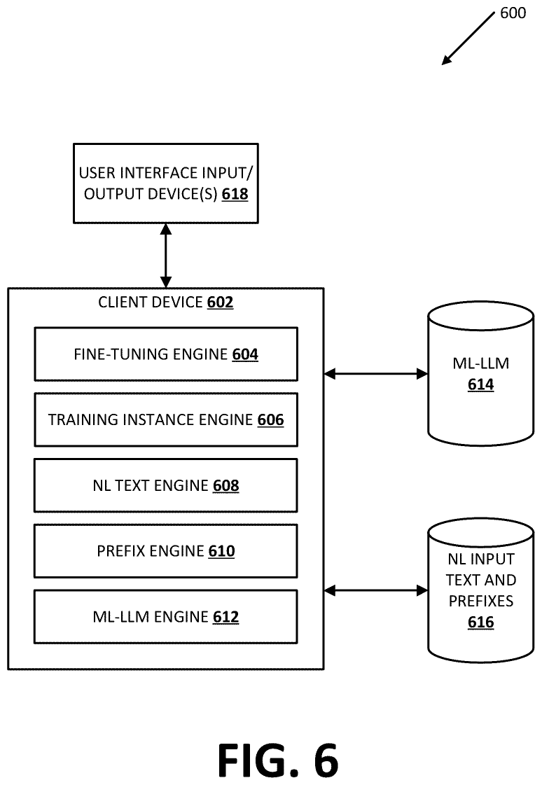

FIG. 6 illustrates a block diagram of an example environment 600 in which various implementations may be implemented. The example environment 600 includes a client device 602 which can include a fine-tuning engine 604, a training instance engine 606, a NL text engine 608, a prefix engine 610, a ML-LLM engine 612, and/or one or more additional or alternative engines (not depicted). Additionally or alternatively, client device 602 may be associated with ML-LLM 614, NL input text and prefixes 616, and/or one or more additional or alternative components (not depicted).

In some implementations, client device 602 may include user interface input/output devices 618, which may include, for example, a physical keyboard, a touch screen (e.g., implementing a virtual keyboard or other textual input mechanisms), a microphone, a camera, a display screen, and/or speaker(s). Additionally or alternatively, client device 602 can include a variety of sensors (not depicted) such as an accelerometer, a gyroscope, a Global Positioning System (GPS), a pressure sensor, a light sensor, a distance sensor, a proximity sensor, a temperature sensor, one or more additional sensors, and/or combinations thereof. The user interface input/output devices 618 may be incorporated with one or more client devices 602 of a user. For example, a mobile phone of the user may include the user interface input output devices; a standalone digital assistant hardware device may include the user interface input/output device; a first computing device may include the user interface input device(s) and a separate computing device may include the user interface output device(s); etc. In some implementations, all or aspects of client device 602 may be implemented on a computing system that also contains the user interface input/output devices 618.

In some implementations client device 602 may include an automated assistant (not depicted), and all or aspects of the automated assistant may be implemented on computing device(s) that are separate and remote from the client device that contains the user interface input/output devices (e.g., all or aspects may be implemented “in the cloud”). In some of those implementations, those aspects of the automated assistant may communicate with the computing device via one or more networks such as a local area network (LAN) and/or a wide area network (WAN) (e.g., the Internet).

Some non-limiting examples of client device 602 include one or more of: a desktop computing device, a laptop computing device, a standalone hardware device at least in part dedicated to an automated assistant, a tablet computing device, a mobile phone computing device, a computing device of a vehicle (e.g., an in-vehicle communications system, and in-vehicle entertainment system, an in-vehicle navigation system, an in-vehicle navigation system), or a wearable apparatus of the user that includes a computing device (e.g., a watch of the user having a computing device, glasses of the user having a computing device, a virtual or augmented reality computing device). Additional and/or alternative computing systems may be provided. Client device 602 may include one or more memories for storage of data and software applications, one or more processors for accessing data and executing applications, and other components that facilitate communication over a network. The operations performed by client device 602 may be distributed across multiple computing devices. For example, computing programs running on one or more computers in one or more locations can be coupled to each other through a network.

In some implementations, the system can use training instance engine 606 to generate one or more training instances based on processing one or more instances of NL input text and prefixes 616. In some implementations, the training instance engine 606 can generate training instance(s) in accordance with process 300 described herein with respect to FIG. 3. In some implementations, the system can use fine-tuning engine 604 to process one or more training instances to fine-tune ML-LLM 614. In some implementations, the fine-tuning engine 604 can fine-tune the ML-LLM 614 in accordance with process 400 described herein with respect to FIG. 4.

In some implementations, the NL text engine 608 can process one or more base instances of NL input text to generate one or more corresponding revised instances of NL input text. In some implementations, ML-LLM engine 612 can process one or more instances of NL input text using ML-LLM 614 to generate responsive output. For example, the ML-LLM engine 612 can process NL input text using ML-LLM 614 in accordance accordance with process 500 of FIG. 5 described herein.

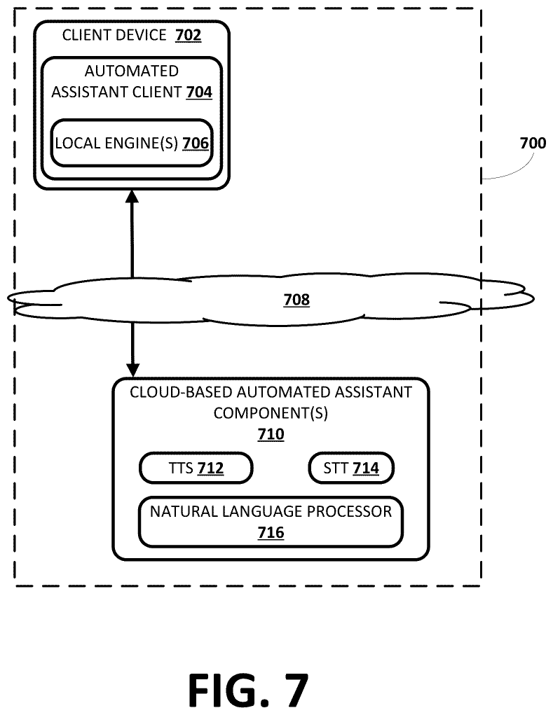

Turning now to FIG. 7, an example environment is illustrated where various implementations can be performed. FIG. 7 is described initially, and includes a client computing device 702, which executes an instance of an automated assistant client 704. One or more cloud-based automated assistant components 710 can be implemented on one or more computing systems (collectively referred to as a “cloud” computing system) that are communicatively coupled to client device 702 via one or more local and/or wide area networks (e.g., the Internet) indicated generally at 708.

An instance of an automated assistant client 704, by way of its interactions with one or more cloud-based automated assistant components 710, may form what appears to be, from the user's perspective, a logical instance of an automated assistant 700 with which the user may engage in a human-to-computer dialog. An instance of such an automated assistant 700 is depicted in FIG. 7. It thus should be understood that in some implementations, a user that engages with an automated assistant client 704 executing on client device 702 may, in effect, engage with his or her own logical instance of an automated assistant 700. For the sakes of brevity and simplicity, the term “automated assistant” as used herein as “serving” a particular user will often refer to the combination of an automated assistant client 704 executing on a client device 702 operated by the user and one or more cloud-based automated assistant components 710 (which may be shared amongst multiple automated assistant clients of multiple client computing devices). It should also be understood that in some implementations, automated assistant 700 may respond to a request from any user regardless of whether the user is actually “served” by that particular instance of automated assistant 700.

The client computing device 702 may be, for example: a desktop computing device, a laptop computing device, a tablet computing device, a mobile phone computing device, a computing device of a vehicle of the user (e.g., an in-vehicle communications system, an in-vehicle entertainment system, an in-vehicle navigation system), a standalone interactive speaker, a smart appliance such as a smart television, and/or a wearable apparatus of the user that includes a computing device (e.g., a watch of the user having a computing device, glasses of the user having a computing device, a virtual or augmented reality computing device). Additional and/or alternative client computing devices may be provided. In various implementations, the client computing device 702 may optionally operate one or more other applications that are in addition to automated assistant client 704, such as a message exchange client (e.g., SMS, MMS, online chat), a browser, and so forth. In some of those various implementations, one or more of the other applications can optionally interface (e.g., via an application programming interface) with the automated assistant 700, or include their own instance of an automated assistant application (that may also interface with the cloud-based automated assistant component(s) 710).

Automated assistant 700 engages in human-to-computer dialog sessions with a user via user interface input and output devices of the client device 702. To preserve user privacy and/or to conserve resources, in many situations a user must often explicitly invoke the automated assistant 700 before the automated assistant will fully process a spoken utterance. The explicit invocation of the automated assistant 700 can occur in response to certain user interface input received at the client device 702. For example, user interface inputs that can invoke the automated assistant 700 via the client device 702 can optionally include actuations of a hardware and/or virtual button of the client device 702. Moreover, the automated assistant client can include one or more local engines 706, such as an invocation engine that is operable to detect the presence of one or more spoken invocation phrases. The invocation engine can invoke the automated assistant 700 in response to detection of one of the spoken invocation phrases. For example, the invocation engine can invoke the automated assistant 700 in response to detecting a spoken invocation phrase such as “Hey Assistant,” “OK Assistant”, and/or “Assistant”. The invocation engine can continuously process (e.g., if not in an “inactive” mode) a stream of audio data frames that are based on output from one or more microphones of the client device 702, to monitor for an occurrence of a spoken invocation phrase. While monitoring for the occurrence of the spoken invocation phrase, the invocation engine discards (e.g., after temporary storage in a buffer) any audio data frames that do not include the spoken invocation phrase. However, when the invocation engine detects an occurrence of a spoken invocation phrase in processed audio data frames, the invocation engine can invoke the automated assistant 700. As used herein, “invoking” the automated assistant 700 can include causing one or more previously inactive functions of the automated assistant 700 to be activated. For example, invoking the automated assistant 700 can include causing one or more local engines 706 and/or cloud-based automated assistant components 710 to further process audio data frames based on which the invocation phrase was detected, and/or one or more following audio data frames (whereas prior to invoking no further processing of audio data frames was occurring).

The one or more local engine(s) 706 of automated assistant 700 are optional, and can include, for example, fine-tuning engine 604, training instance engine 606, NL text engine 608, prefix engine 610, and/or ML-LLM engine 612 described above, a local voice-to-text (“STT”) engine (that converts captured audio to text), a local text-to-speech (“TTS”) engine (that converts text to speech), a local natural language processor (that determines semantic meaning of audio and/or text converted from audio), and/or other local components. Because the client device 702 is relatively constrained in terms of computing resources (e.g., processor cycles, memory, battery, etc.), the local engines 706 may have limited functionality relative to any counterparts that are included in cloud-based automated assistant components 710.

Cloud-based automated assistant components 710 leverage the virtually limitless resources of the cloud to perform more robust and/or more accurate processing of audio data, and/or other user interface input, relative to any counterparts of the local engine(s) 706. Again, in various implementations, the client device 702 can provide audio data and/or other data to the cloud-based automated assistant components 710 in response to the invocation engine detecting a spoken invocation phrase, or detecting some other explicit invocation of the automated assistant 700.

The illustrated cloud-based automated assistant components 710 include a cloud-based TTS module 712, a cloud-based STT module 714, a natural language processor 716, a dialog state tracker 718, and a dialog manager 720. In some implementations, one or more of the engines and/or modules of automated assistant 700 may be omitted, combined, and/or implemented in a component that is separate from automated assistant 700. Further, in some implementations automated assistant 700 can include additional and/or alternative engines and/or modules. Cloud-based STT module 714 can convert audio data into text, which may then be provided to natural language processor 716.

Cloud-based TTS module 712 can convert textual data (e.g., natural language responses formulated by automated assistant 700) into computer-generated speech output. In some implementations, TTS module 712 may provide the computer-generated speech output to client device 702 to be output directly, e.g., using one or more speakers. In other implementations, textual data (e.g., natural language responses) generated by automated assistant 700 may be provided to one of the local engine(s) 706, which may then convert the textual data into computer-generated speech that is output locally.

Natural language processor 716 of automated assistant 700 processes free form natural language input and generates, based on the natural language input, annotated output for use by one or more other components of the automated assistant 700. For example, the natural language processor 716 can process natural language free-form input that is textual input that is a conversion, by STT module 714, of audio data provided by a user via client device 702. The generated annotated output may include one or more annotations of the natural language input and optionally one or more (e.g., all) of the terms of the natural language input.

In some implementations, the natural language processor 716 is configured to identify and annotate various types of grammatical information in natural language input. In some implementations, the natural language processor 716 may additionally and/or alternatively include an entity tagger (not depicted) configured to annotate entity references in one or more segments such as references to people (including, for instance, literary characters, celebrities, public figures, etc.), organizations, locations (real and imaginary), and so forth. In some implementations, the natural language processor 716 may additionally and/or alternatively include a coreference resolver (not depicted) configured to group, or “cluster,” references to the same entity based on one or more contextual cues. For example, the coreference resolver may be utilized to resolve the term “there” to “Hypothetical Café” in the natural language input “I liked Hypothetical Café last time we ate there.” In some implementations, one or more components of the natural language processor 716 may rely on annotations from one or more other components of the natural language processor 716. In some implementations, in processing a particular natural language input, one or more components of the natural language processor 716 may use related prior input and/or other related data outside of the particular natural language input to determine one or more annotations.

In some implementations, dialog state tracker 718 may be configured to keep track of a “dialog state” that includes, for instance, a belief state of a one or more users' goals (or “intents”) over the course of a human-to-computer dialog session and/or across multiple dialog sessions. In determining a dialog state, some dialog state trackers may seek to determine, based on user and system utterances in a dialog session, the most likely value(s) for slot(s) that are instantiated in the dialog. Some techniques utilize a fixed ontology that defines a set of slots and the set of values associated with those slots. Some techniques additionally or alternatively may be tailored to individual slots and/or domains. For example, some techniques may require training a model for each slot type in each domain.

Dialog manager 720 may be configured to map a current dialog state, e.g., provided by dialog state tracker 718, to one or more “responsive actions” of a plurality of candidate responsive actions that are then performed by automated assistant 700. Responsive actions may come in a variety of forms, depending on the current dialog state. For example, initial and midstream dialog states that correspond to turns of a dialog session that occur prior to a last turn (e.g., when the ultimate user-desired task is performed) may be mapped to various responsive actions that include automated assistant 700 outputting additional natural language dialog. This responsive dialog may include, for instance, requests that the user provide parameters for some action (i.e., fill slots) that dialog state tracker 718 believes the user intends to perform. In some implementations, responsive actions may include actions such as “request” (e.g., seek parameters for slot filling), “offer” (e.g., suggest an action or course of action for the user), “select,” “inform” (e.g., provide the user with requested information), “no match” (e.g., notify the user that the user's last input is not understood), a command to a peripheral device (e.g., to turn off a light bulb), and so forth.

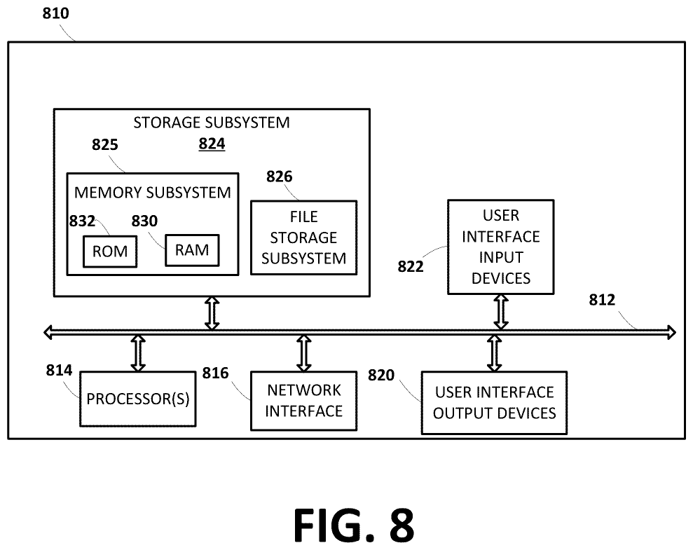

FIG. 8 is a block diagram of an example computing device 810 that may optionally be utilized to perform one or more aspects of techniques described herein. In some implementations, one or more of a client computing device, and/or other component(s) may comprise one or more components of the example computing device 810.

Computing device 810 typically includes at least one processor 814 which communicates with a number of peripheral devices via bus subsystem 812. These peripheral devices may include a storage subsystem 824, including, for example, a memory subsystem 825 and a file storage subsystem 826, user interface output devices 820, user interface input devices 822, and a network interface subsystem 816. The input and output devices allow user interaction with computing device 810. Network interface subsystem 816 provides an interface to outside networks and is coupled to corresponding interface devices in other computing devices.

User interface input devices 822 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computing device 810 or onto a communication network.

User interface output devices 820 may include a display subsystem, a printer, a fax machine, or non-visual displays such as audio output devices. The display subsystem may include a cathode ray tube (“CRT”), a flat-panel device such as a liquid crystal display (“LCD”), a projection device, or some other mechanism for creating a visible image. The display subsystem may also provide non-visual display such as via audio output devices. In general, use of the term “output device” is intended to include all possible types of devices and ways to output information from computing device 810 to the user or to another machine or computing device.

Storage subsystem 824 stores programming and data constructs that provide the functionality of some or all of the modules described herein. For example, the storage subsystem 824 may include the logic to perform selected aspects of one or more of the processes of FIG. 3, FIG. 4, and/or FIG. 5, as well as to implement various components depicted in FIG. 6 and/or FIG. 7.

These software modules are generally executed by processor 814 alone or in combination with other processors. Memory 825 used in the storage subsystem 824 can include a number of memories including a main random access memory (“RAM”) 830 for storage of instructions and data during program execution and a read only memory (“ROM”) 832 in which fixed instructions are stored. A file storage subsystem 826 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 826 in the storage subsystem 824, or in other machines accessible by the processor(s) 814.

Bus subsystem 812 provides a mechanism for letting the various components and subsystems of computing device 810 communicate with each other as intended. Although bus subsystem 812 is shown schematically as a single bus, alternative implementations of the bus subsystem may use multiple buses.

Computing device 810 can be of varying types including a workstation, server, computing cluster, blade server, server farm, or any other data processing system or computing device. Due to the ever-changing nature of computers and networks, the description of computing device 810 depicted in FIG. 8 is intended only as a specific example for purposes of illustrating some implementations. Many other configurations of computing device 810 are possible having more or fewer components than the computing device depicted in FIG. 8.

In situations in which the systems described herein collect personal information about users (or as often referred to herein, “participants”), or may make use of personal information, the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

In some implementations, a method implemented by one or more processors is provided, the method includes fine-tuning a multilingual large language model (ML-LLM). In some implementations, fine-tuning the ML-LLM includes identifying a base instance of natural language (NL) input text in a first language that includes a portion corresponding to a first geographic location, where the base instance of NL input text is paired with a first prefix that includes an indication of the first language and an indication of the first geographic location. In some implementations, the method further includes converting the base instance of NL input text in the first language into an revised instance of NL input text in a second language that includes a portion corresponding to a second geographic location, where the revised instance of NL input text, based on the converting, is paired with a second prefix that includes an indication of the second language and an indication of the second geographic location, wherein the second language is distinct from the first language, and wherein the second geographic location is distinct from the first geographic location. In some implementations, the method further includes fine-tuning the ML-LLM based on comparing (1) base output, generated by processing the base instance of NL input text using the ML-LLM, and the first prefix with (2) revised output, generated based on processing the revised instance of NL input text using the ML-LLM, and the second prefix.

These and other implementations of the technology can include one or more of the following features.

In some implementations, converting the base instance of NL input text in the first language into the revised instance of NL input text in the second language includes processing the portion of the base instance of NL input text corresponding to the first geographic location to generate an updated portion of the base instance of NL input text that corresponds to the second geographic location and is in the first language. In some implementations, the method further includes generating an updated instance of NL input text by replacing, in the base instance of NL input text, the portion corresponding to the first geographic location with the updated portion of the base instance of NL input text that corresponds to the second geographic location. In some implementations, the method further includes generating the revised instance of NL input text by translating the updated instance of NL input text from the first language into the second language.

In some versions of those implementations, processing the portion of the base instance of NL input text corresponding to the first geographic location to generate the updated portion of the base instance of NL input text that corresponds to the second geographic location and is in the first language includes processing the portion of the base instance of NL input text corresponding to the first geographic location using a knowledge graph to identify a base node indicating the portion of the base instance of NL input corresponding to the first geographic location. In some implementations, the method further includes processing the second geographic location using the knowledge graph to identify an updated node which corresponds to the base node at the second geographic location. In some implementations, the method further includes generating the updated portion of the base instance of NL input text that corresponds to the second geographic location based on the updated node.

In some versions of those implementations, processing the portion of the base instance of NL input text corresponding to the first geographic location to generate the updated portion of the base instance of NL input text that corresponds to the second geographic location and is in the first language includes generating a search query which includes at least the portion of the base instance of NL input text corresponding to the first geographic location and the second geographic location. In some implementations, the method further includes processing the search query using a search engine to generate the updated portion of the base instance of NL input text that corresponds to the second geographic location and is in the first language.

In some versions of those implementations, processing the portion of the base instance of NL input text corresponding to the first geographic location to generate the updated portion of the base instance of NL input text that corresponds to the second geographic location and is in the first language includes generating a NL text query based on at least the portion of the base instance of NL input text corresponding to the first geographic location and the second geographic location. In some implementations, the method further includes processing the NL text query using a generative model (GM) to generate the updated portion of the base instance of NL input text that corresponds to the second geographic location and is in the first language.

In some implementations, the first geographic location is a first country and the second geographic location is a second country, where the first country is distinct from the second country.

In some implementations, the first geographic location is a first city and the second geographic location is a second city, where the first city is distinct from the second city.

In some implementations, a method implemented by one or more processors is provided, the method includes identifying an instance of natural language (NL) input spoken by a user in a given language. In some implementations, the method includes generating a prefix corresponding to the instance of NL input, where the prefix includes an indication of the given language and an indication of a given geographic location of the instance of NL input. In some implementations, the method includes processing the instance of NL input and the prefix using a fine-tuned multilingual large language model (ML-LLM) to generate output responsive to the instance of NL input, wherein the ML-LLM is fine-tuned based on at least an instance multilingual NL input text training data which includes (1) a base instance of NL input text in a first language that includes a portion corresponding to a first geographic location and (2) a revised instance of NL input text in a second language that includes a portion corresponding to the second geographic location, and wherein fine-tuning the ML-LLM comprises comparing base output, generated by processing the base instance of NL input text using the ML-LLM with revised output, generated based on processing the revised instance of NL input text using the ML-LLM.

These and other implementations of the technology can include one or more of the following features.

In some implementations, the revised instance of NL input is generated based on converting the base instance of NL input text in the first language into the revised instance of NL input text in the second language, wherein the first language is distinct from the second language, and wherein the first geographic location is distinct from the second geographic location.

In some versions of those implementations, converting the base instance of NL input text in the first language into the revised instance of NL input text in the second language includes processing the portion of the base instance of NL input text corresponding to the first geographic location to generate an updated portion of the base instance of NL input text that corresponds to the second geographic location and is in the first language. In some implementations, the method further includes generating an updated instance of NL input text by replacing, in the base instance of NL input text, the portion corresponding to the first geographic location with the updated portion of the base instance of NL input text that corresponds to the second geographic location. In some implementations, the method further includes generating the revised instance of NL input text by translating the updated instance of NL input text from the first language into the second language.

In some versions of those implementations, processing the portion of the base instance of NL input text corresponding to the first geographic location to generate the updated portion of the base instance of NL input text that corresponds to the second geographic location and is in the first language includes processing the portion of the base instance of NL input text corresponding to the first geographic location using a knowledge graph to identify a base node indicating the portion of the base instance of NL input corresponding to the first geographic location. In some versions of those implementations, the method further includes processing the second geographic location using the knowledge graph to identify an updated node which corresponds to the base node at the second geographic location. In some versions of those implementations, the method further includes generating the updated portion of the base instance of NL input text that corresponds to the second geographic location based on the updated node.

In some versions of those implementations, processing the portion of the base instance of NL input text corresponding to the first geographic location to generate the updated portion of the base instance of NL input text that corresponds to the second geographic location and is in the first language includes generating a search query which includes at least the portion of the base instance of NL input text corresponding to the first geographic location and the second geographic location. In some versions of those implementations, the method further includes processing the search query using a search engine to generate the updated portion of the base instance of NL input text that corresponds to the second geographic location and is in the first language.

In some versions of those implementations, processing the portion of the base instance of NL input text corresponding to the first geographic location to generate the updated portion of the base instance of NL input text that corresponds to the second geographic location and is in the first language includes generating a NL text query based on at least the portion of the base instance of NL input text corresponding to the first geographic location and the second geographic location. In some versions of those implementations, the method further includes processing the NL text query using a generative model (GM) to generate the updated portion of the base instance of NL input text that corresponds to the second geographic location and is in the first language.

In some implementations, the first geographic location is a first country and the second geographic location is a second country, where the first country is distinct from the second country.

In some implementations, the first geographic location is a first city and the second geographic location is a second city, where the first city is distinct from the second city.

What is claimed is:

1. A method implemented by one or more processors, the method comprising:
fine-tuning a multilingual large language model (ML-LLM), wherein fine-tuning the ML-LLM comprises:
identifying a base instance of natural language (NL) input text in a first language that includes a portion corresponding to a first geographic location, where the base instance of NL input text is paired with a first prefix that includes an indication of the first language and an indication of the first geographic location;
converting the base instance of NL input text in the first language into an revised instance of NL input text in a second language that includes a portion corresponding to a second geographic location, where the revised instance of NL input text, based on the converting, is paired with a second prefix that includes an indication of the second language and an indication of the second geographic location, wherein the second language is distinct from the first language, and wherein the second geographic location is distinct from the first geographic location; and
fine-tuning the ML-LLM based on comparing (1) base output, generated by processing the base instance of NL input text using the ML-LLM, and the first prefix with (2) revised output, generated based on processing the revised instance of NL input text using the ML-LLM, and the second prefix.

2. The method of claim 1, wherein converting the base instance of NL input text in the first language into the revised instance of NL input text in the second language comprises:
processing the portion of the base instance of NL input text corresponding to the first geographic location to generate an updated portion of the base instance of NL input text that corresponds to the second geographic location and is in the first language;
generating an updated instance of NL input text by replacing, in the base instance of NL input text, the portion corresponding to the first geographic location with the updated portion of the base instance of NL input text that corresponds to the second geographic location; and
generating the revised instance of NL input text by translating the updated instance of NL input text from the first language into the second language.

3. The method of claim 2, wherein processing the portion of the base instance of NL input text corresponding to the first geographic location to generate the updated portion of the base instance of NL input text that corresponds to the second geographic location and is in the first language comprises:
processing the portion of the base instance of NL input text corresponding to the first geographic location using a knowledge graph to identify a base node indicating the portion of the base instance of NL input corresponding to the first geographic location;
processing the second geographic location using the knowledge graph to identify an updated node which corresponds to the base node at the second geographic location; and
generating the updated portion of the base instance of NL input text that corresponds to the second geographic location based on the updated node.

4. The method of claim 2, wherein processing the portion of the base instance of NL input text corresponding to the first geographic location to generate the updated portion of the base instance of NL input text that corresponds to the second geographic location and is in the first language comprises:
generating a search query which includes at least the portion of the base instance of NL input text corresponding to the first geographic location and the second geographic location; and
processing the search query using a search engine to generate the updated portion of the base instance of NL input text that corresponds to the second geographic location and is in the first language.

5. The method of claim 2, wherein processing the portion of the base instance of NL input text corresponding to the first geographic location to generate the updated portion of the base instance of NL input text that corresponds to the second geographic location and is in the first language comprises:
generating a NL text query based on at least the portion of the base instance of NL input text corresponding to the first geographic location and the second geographic location;
processing the NL text query using a generative model (GM) to generate the updated portion of the base instance of NL input text that corresponds to the second geographic location and is in the first language.

6. The method of claim 1, wherein the first geographic location is a first country and the second geographic location is a second country, where the first country is distinct from the second country.

7. The method of claim 1, wherein the first geographic location is a first city and the second geographic location is a second city, where the first city is distinct from the second city.

8. A method implemented by one or more processors, the method comprising:
identifying an instance of natural language (NL) input spoken by a user in a given language;
generating a prefix corresponding to the instance of NL input, where the prefix includes an indication of the given language and an indication of a given geographic location of the instance of NL input; and
processing the instance of NL input and the prefix using a fine-tuned multilingual large language model (ML-LLM) to generate output responsive to the instance of NL input,
wherein the ML-LLM is fine-tuned based on at least an instance multilingual NL input text training data which includes (1) a base instance of NL input text in a first language that includes a portion corresponding to a first geographic location and (2) a revised instance of NL input text in a second language that includes a portion corresponding to the second geographic location, and wherein fine-tuning the ML-LLM comprises comparing base output, generated by processing the base instance of NL input text using the ML-LLM with revised output, generated based on processing the revised instance of NL input text using the ML-LLM.

9. The method of claim 8, wherein the revised instance of NL input is generated based on converting the base instance of NL input text in the first language into the revised instance of NL input text in the second language, wherein the first language is distinct from the second language, and wherein the first geographic location is distinct from the second geographic location.

10. The method of claim 9, wherein converting the base instance of NL input text in the first language into the revised instance of NL input text in the second language comprises:
processing the portion of the base instance of NL input text corresponding to the first geographic location to generate an updated portion of the base instance of NL input text that corresponds to the second geographic location and is in the first language;
generating an updated instance of NL input text by replacing, in the base instance of NL input text, the portion corresponding to the first geographic location with the updated portion of the base instance of NL input text that corresponds to the second geographic location; and
generating the revised instance of NL input text by translating the updated instance of NL input text from the first language into the second language.

11. The method of claim 10, wherein processing the portion of the base instance of NL input text corresponding to the first geographic location to generate the updated portion of the base instance of NL input text that corresponds to the second geographic location and is in the first language comprises:
processing the portion of the base instance of NL input text corresponding to the first geographic location using a knowledge graph to identify a base node indicating the portion of the base instance of NL input corresponding to the first geographic location;
processing the second geographic location using the knowledge graph to identify an updated node which corresponds to the base node at the second geographic location; and
generating the updated portion of the base instance of NL input text that corresponds to the second geographic location based on the updated node.

12. The method of claim 10, wherein processing the portion of the base instance of NL input text corresponding to the first geographic location to generate the updated portion of the base instance of NL input text that corresponds to the second geographic location and is in the first language comprises:
generating a search query which includes at least the portion of the base instance of NL input text corresponding to the first geographic location and the second geographic location; and
processing the search query using a search engine to generate the updated portion of the base instance of NL input text that corresponds to the second geographic location and is in the first language.

13. The method of claim 10, wherein processing the portion of the base instance of NL input text corresponding to the first geographic location to generate the updated portion of the base instance of NL input text that corresponds to the second geographic location and is in the first language comprises:
generating a NL text query based on at least the portion of the base instance of NL input text corresponding to the first geographic location and the second geographic location;
processing the NL text query using a generative model (GM) to generate the updated portion of the base instance of NL input text that corresponds to the second geographic location and is in the first language.

14. The method of claim 8, wherein the first geographic location is a first country and the second geographic location is a second country, where the first country is distinct from the second country.

15. The method of claim 8, wherein the first geographic location is a first city and the second geographic location is a second city, where the first city is distinct from the second city.

16. A client device comprising:
one or more processors, and
memory configured to store instructions that, when executed by the one or more processors, cause the one or more processors to perform a method that includes:
identifying an instance of natural language (NL) input spoken by a user in a given language;
generating a prefix corresponding to the instance of NL input, where the prefix includes an indication of the given language and an indication of a given geographic location of the instance of NL input; and
processing the instance of NL input and the prefix using a fine-tuned multilingual large language model (ML-LLM) to generate output responsive to the instance of NL input,
wherein the ML-LLM is fine-tuned based on at least an instance multilingual NL input text training data which includes (1) a base instance of NL input text in a first language that includes a portion corresponding to a first geographic location and (2) a revised instance of NL input text in a second language that includes a portion corresponding to the second geographic location, and wherein fine-tuning the ML-LLM comprises comparing base output, generated by processing the base instance of NL input text using the ML-LLM with revised output, generated based on processing the revised instance of NL input text using the ML-LLM.

17. The client device of claim 16, wherein the revised instance of NL input is generated based on converting the base instance of NL input text in the first language into the revised instance of NL input text in the second language, wherein the first language is distinct from the second language, and wherein the first geographic location is distinct from the second geographic location.

18. The client device of claim 17, wherein converting the base instance of NL input text in the first language into the revised instance of NL input text in the second language comprises:
processing the portion of the base instance of NL input text corresponding to the first geographic location to generate an updated portion of the base instance of NL input text that corresponds to the second geographic location and is in the first language;
generating an updated instance of NL input text by replacing, in the base instance of NL input text, the portion corresponding to the first geographic location with the updated portion of the base instance of NL input text that corresponds to the second geographic location; and
generating the revised instance of NL input text by translating the updated instance of NL input text from the first language into the second language.

19. The client device of claim 18, wherein processing the portion of the base instance of NL input text corresponding to the first geographic location to generate the updated portion of the base instance of NL input text that corresponds to the second geographic location and is in the first language comprises:
processing the portion of the base instance of NL input text corresponding to the first geographic location using a knowledge graph to identify a base node indicating the portion of the base instance of NL input corresponding to the first geographic location;
processing the second geographic location using the knowledge graph to identify an updated node which corresponds to the base node at the second geographic location; and
generating the updated portion of the base instance of NL input text that corresponds to the second geographic location based on the updated node.

20. The client device of claim 18, wherein processing the portion of the base instance of NL input text corresponding to the first geographic location to generate the updated portion of the base instance of NL input text that corresponds to the second geographic location and is in the first language comprises:
generating a search query which includes at least the portion of the base instance of NL input text corresponding to the first geographic location and the second geographic location; and
processing the search query using a search engine to generate the updated portion of the base instance of NL input text that corresponds to the second geographic location and is in the first language.
